(19) United States
(12) Patent Application Publication
(10) Pub. No.: US 2023/0101451 A1
(43) Pub. Date: Mar. 30, 2023

(54) Automatic Refinement of Customizable Forecasts for Strategic Management

(71) Applicant: Robert E. Dowing, Pittsburgh, PA (US)

(72) Inventor: Robert E. Dowing, Pittsburgh, PA (US)

(21) Appl. No.: 17/300,362

(22) Filed: May 27, 2021

(51) Int. Cl. G06Q 10/04; G06Q 10/0637

(52) U.S. Cl. CPC G06Q 10/04; G06Q 10/06375

(57) ABSTRACT

An innovative pre-programmed full-fledged computer application that integrates forecasting with strategic management practice streamlining same. The automatic refinement algorithm sequence providing multiple forecasts per each change and unique structure enable decisions or strategies with greater certainty in sustaining actions taken towards desired outcomes. Its uniform format and structure retain focus by serving as a common tool that maintains common aspirations and enables assessment of multiple strategic management approaches simultaneously. Embodiments of convenience in this independent standalone application including customizable time horizons, qualitative projection index, automatic multiple forecasts, reevaluations without reinitialization, and mathematical simplicity and ease of use for non-technical or unskilled help improve operational difficulty, efficiency, strategic management practices, and functioning of forecasting technology towards anticipation of disruptions, evaluation, and control in implementation beyond existing tools.

### CROSS-REFERENCE TO RELATED PATENT APPLICATIONS

U.S. design patent No. D774,506 was issued 12-1-15. It is an ornamental concept without an operating mechanism being directed to an inoperable resource planning entity, void of process, and has not been used in commerce. There are no co-pending utility applications.

### COMPUTER PROGRAM LISTING APPENDIX

References in this paragraph are not for publication. The invention is an improvement to a computer program. This patent application therefore includes a computer listing under 37 CFR 1.96(c) on 2 compact discs prefaced with “Computer Program Listing Appendix” titled “CD Coding” in duplicate containing a Sec. 1.96(c) file titled “Computer Instructions by Drawing Views” of Figures referenced in description of drawing herein and having more than 300 lines of 72 characters per line (176,128 bytes). Each is marked “Copy I” and “Copy 2”.

### FEDERALLY SPONSORED RESEARCH

Not Applicable

### PARTIES TO A JOINT RESEARCH AGREEMENT

Not Applicable

### PRIOR DISCLOSURES

No prior art is disclosed subject to 35 U.S.C. § 102(a)(2) since no other inventor is named and 35 U.S.C. § 102(b)(2)(A)-(B) would otherwise apply. All parenthetical notations of “Ref.” in this document refer to the Technical References listed on the first page of “Appendix to Declaration”.

### BACKGROUND

### 1. Technical Field

The invention pertains to the technical field of strategic management for a business, group, or person that embodies formulation, evaluation, and implementation considering available resources and impacts for effectively meeting goals in the future. U.S. patent classification Class 705/7.36 for “strategic management and analysis” defines this as “Subject matter drawn to a computerized arrangement for providing overall direction to a business by (1) developing a business mission, vision, or objective, (2) formulating a planned course of action . . . or (3) evaluating or reevaluating whether the . . . mission, vision, or objective or planned course of action was effective, produced a desired outcome, or needs to be modified”. This subclass is indented under Class 705/7.11 Operations Research or Analysis. Forecasting is integral to the process. U.S. patent Class 705/7.37 prediction of business outcome or impact is indented under subclass 7.36 being related to aspects of its alternative review and implementation stages. The general planning process and control are sufficient. Strategic management being action-oriented with control in taking actions on priorities already set differs from strategic planning being analytical-oriented with identification of actions used to set priorities. Strategic planning is an aspect of strategic management. While the “Journal of Strategic Management” attests the field as methodological study rather than automated, the invention helps operationalize it's formulation and implementation through automation and structure.

“Strategy” is a planned way of doing something to achieve a specific purpose. The Oxford Dictionary definition of “strategic” as an adjective “relating to the identification of long-term or overall aims and interests and the means of achieving them” is relevant. Traditionally, the field is viewed as a process for managers' strategies usually directed at competition decisions. However, the field is extended here to anyone with control of resources and actions in consideration of current conditions related to the pandemic and environment. “Resources” as applied here are people, policy, infrastructure or configuration, finances, services, natural, materials, information, location, time, distance or measure, etc. Structure organized for inputs transformable to future numeric levels upon which to base actions encompass user-designated ‘elements’ or indicators within strategy or planning areas such as: customary operations; KPIs or milestones; impact factors; known disruption insights; special planning (environmental, energy, transportation, convention, career, etc); personal or group aspirations (fund-raising, growth, information); etc. The owner, administrator, or administrative group primarily responsible for operating the invention, as available, serves the traditional manager's or management team's role in controlling resources and actions.

Practice in this field varies widely. Conventional strategic management is an extremely time-consuming process (data compilation, consultations, consensus-building). The most extensive survey of practices used as conducted by the Univ of Prishtina's in 2017 found the three most used tools and techniques were SWOT analysis, benchmarking, and PEST analysis (Ref. 2). Templates are available for SWOT and PEST. It notes that most SMEs and LEs use multiple approaches and “strategic planning, budgeting, and business strategies were not the most used tools” in the top ten. The invention applies a general planning process combined with the parenthetical resultant Flextor.com stage including “control” given wide variations of strategic management approaches between formulation and implementation. This process's steps include: (1) recognize an issue exists (identify issues and preliminary goals or perspectives); (2) define problem (analyze needs); (3) set goals and objectives; (4) review alternatives (formulate strategies—assess conditions and updates, prioritize); (5) decide course of action (consider resources and impacts); (6) implement actions (implement—take actions, control levels, evaluate results); (7) monitor (measure performance; reassess, adapt—make corrective actions or adjustments). Descriptions of the field's processes typically mention assessment of internal and external environments relevant to SME or LE operations. The invention references “impacts” here as both the internal-external environments serving the user and interdependency factors, regardless of industry, with those that the user's strategic action(s) affect or provide mutual benefits. Formulation may be viewed as steps 1-3 and implementation as steps 4-7 under the above process. The process is iterative and dynamic. Functioning of strategic management is its process. Practice is how the process is performed.

As relevant to the invention, “functionality” and “ancillary” combined further establish a consistency overall in formulating goals, helping establish impacts or assessment of internal and external environments, adapting to change. “Functionality” here is capacity of a computer application or its set of functions and capabilities to provide a useful function or outcome; “ancillary” is defined by the Oxford Dictionary as “providing necessary support to the primary activities or operation of an organization, system, etc”.

### 2. Background Art

### a. Technical Aspects

Related art of the invention is forecasting technology. Forecasting is a planning tool used to predict a future situation or condition at a specific point in assisting decisions or strategies. Forecasting is necessary in strategic management to indicate a level of long-term effectiveness and sustainability. As the related art in this invention, it is present in any strategic or planning area applied by the user to better achieve this end purpose. It has routinely gone from computers to programmable calculators. “Forecasting Software: Past, Present, and Future” (Ref. 3) published in the Journal of International Forecasting is an authoritative source on forecasting technology. It's website states that the Journal “is a quarterly peer-reviewed scientific journal of forecasting”. “Technology” defined as “a manner of accomplishing a task especially using technical processes, methods, or knowledge” is sufficient (Webster's online dictionary). In recognizing that computer architecture or hardware is the determinant of “computer technology”, the art of forecasting technology as applied in the invention refers to “any other technology” beside “computer”. One definition of “technological” as “resulting from improvements in technical processes that increase productivity of machines and eliminates manual operations” (ibid) is exemplified in this invention by its 24-step automatic refinement algorithm sequence.

Existing technology, products, and practices define the state of the art. Wikipedia.org and other sources define computer architecture as technological standards designed to operate and control a computer's hardware which includes computer platforms and system software. It controls basic computer hardware housekeeping functions of receiving, collecting, storing, analyzing, and displaying data. A computer platform is “computer architecture and equipment using a particular operating system” and system software is “computer software designed to operate and control the computer hardware and to provide a platform for running application software” (Ref. 5).

Application software is “a program with user interface is an application” and “(an application) is a set of one or more programs designed to permit the user to perform a group of coordinated functions, tasks, or activities” . . . which “cannot run on itself being dependent upon the architecture or system software” (Ref. 5). “Source code” is easily understandable human-readable programming code usually in plain text transformed by a compiler into machine code; it is a component which can be part of intellectual property (Ref. 5). Unique source code enables the application software relevant here to perform the function of forecasting levels for elements of strategy areas through user-interfaces on a computer. A “software suite” is a collection of two or more software programs bundled or sold together (Ref. 5).

Tipsandarticles.com notes that computer spreadsheets have basic features of: grids (rows and columns); functions; formulas; commands; text manipulation; printing; interface; title bar; menu bar; tool bar; formula bar; cell; cell address; column header; row header; sheet tab; and status bar. They open as a blank computer application. Some have cross-platform capability (Apple, Android, Windows). Commercially available computer spreadsheets can be a platform serving as a utility tool that can build new application software. Chip Wilson and Alan Josephson noted “Beginning with Microsoft Office 2003, it has been possible to build full-fledged applications on top of Office client applications” (“Microsoft Office as a Platform for Software+Services”, Jan. 13, 2009, Ref. 4). A computer platform definition on components states “An application, such as a spreadsheet . . . an Excel macro . . . can be extended to writing fully-fledged applications with the Microsoft Office suite as a platform” (Wikipedia.org, Ref. 5). Computer spreadsheet data structure, which requires less technological expertise than databases, must use proper design to maintain “data integrity” from manual errors by multiple users (fixed data user wants to see, tabular formats, data validation). The source coding of a new full-fledged application software enables unique functionalities and features to be performed on the platform from pre-programming.

Forecasting software methods include qualitative and quantitative techniques. Qualitative techniques are subjective or intuitive when past data is unavailable and are usually applied to intermediate or long-range periods. Example types include informed opinions or judgement, Delphi method, and market research (surveys). Quantitative techniques rely entirely upon past data (historical data) and are usually applied to short or intermediate-range periods. They include three types: time-series group (naive or last data observed, simple mean time series, moving averages, exponential smoothing, etc.); causal models with underlying relationships such as climate or holidays (regression analysis, autoregressive moving average); and artificial intelligence. Predictive analytics use advanced statistical techniques; the invention does not.

Terms used in some of these methods are relevant. An “index” is a measure of a group of related variables or factors over time or space that indicates a comparative value or effect. A “scenario” in the context of a quantifiable alternative is a what-if view of how another outcome may develop such as scenario tools that require both foreknowledge of what will be needed to be revised beforehand. It requires an additional step to set up making these less operationally efficient than real-time revision of priorities to unanticipated needs. A “key performance indicator” (KPI) is a desired baseline measuring how well an organization has met its goal after performance of an activity but does not predict impact of future conditions by itself; a “metric” is the numeric value of the KPI or what is being measured—covid-19 pandemic lockdown is an example of using both (Ref. 3). Simple percent change indicates an increase, decrease, or no change. Simple percent error is an indication of accuracy for each data element separately but mean absolute percentage error (MAPE) is the statistical method used in routine practice to gauge accuracy of the entire forecast.

Artificial intelligence (AI) as the third type of quantitative forecasting and emerging quantum computing power with enormous amounts of information for simultaneously processing multiple complex tasks are considered. Its advanced statistical techniques and handling of data relationships make it a form of predictive analytics. If the goal of AI is to benefit all humanity, the ultimate aspiration is preservation and conflict resolution. Pragmatically, the upper limit to this ultra-advanced intelligence is preservation of all humans. Setting limits to Al that does not fulfill purposes of reducing dangers to humans or protecting natural human biological functions or by advancing creativity maintains this. Bernard Marr's “6 Practical Examples of How Quantum Computing Will Change Our World” (Ref. 6) noting online security, artificial intelligence, drug development, weather forecasting and climate change, traffic control, and tackling the whole problem exemplifies this. Quantum computing architecture is not yet established sufficiently or commercialized. Therefore, a forecasting technology improvement that enables simultaneously computing forecasts of multiple functions in a digital environ (bits) remains necessary.

No single forecasting technique is appropriate for all situations. For this reason, forecasting is not “fundamental”. Combining individual forecasts have proven to increase accuracy. However, Abhishek Kapoor's “5 Common Challenges in Business Forecasting” notes problems of business forecasting with multiple managers: lack of a common tool for comparable forecasts across units and lack of a common set of assumptions applicable to all given individual approaches (Ref. 7)—a lack of uniformity. Specifically, “It takes weeks for managers across large companies to compile their overall business forecasts. Once . . . the big presentation is rolled up, the biggest challenge is explaining this forecast. Since every manager does forecast differently, makes different assumptions . . . the final forecast lacks a common set of assumptions” (Ref. 7). Some other general characteristics of forecasting technology noted since 1966 to present include: (1) automation or computerization; (2) use of sophisticated statistical techniques; (3) a requirement of technical knowledge or skill; (4) need to integrate forecasts (future situations' data) with planning (desired objectives); (5) need to minimize uncertainty; (6) need for cost-effectiveness (model selection, IT system integration); and (7) need to reduce operational difficulty (data maintenance and update, redundancy in initialization, analytical processes). The invention serves as such common tool.

The general process related to applying forecasting software includes: (1) define the problem, purpose, and time horizon; (2) gather and review information; (3) perform a preliminary analysis of data; (4) select a forecasting technique or software; (5) evaluate the forecasting model(s); and (6) analyze and monitor forecasts for implementation. This consumes a considerable amount of time, staff, and costs. It is a technological process that starts with executable components through technological means. This forecasting process is a technology. Evaluation as an executable component includes reassessing problems (step 1) with adequacy of the forecast model (step 5).

Prior to development of this invention, surveys of products, forecasting software, methods, and appropriate cases were made in 2006-2020 to provide a comparative bases in status of the state of the art. These included the Journal on forecasting software; “Preliminary Product and Patent Search” (Ref. 1) comparing 122 products and patents existing before February 2009; 2020 online search including 25 patents and 33 applications listed in the PAFT under “forecast software”; and some relevant cases such as Thales Visionix, Inc (valid when a mathematical equation is required to complete claimed method or system), Aristocrat Techs (computer-implemented means-plus-function limitation must include algorithm needed), SmithKline Beecham v Apotex (product-by-process must be new) and Bilski (derivation of “organizing human activity” from hedging not applicable to human operation of a machine or “forecasting” such as technology impacts). Innovation to forecasting software remains possible.

The Journal identified the three main needs for improvement of forecasting software as integrating forecasting and planning (including differences in forecast horizons) p. 608, minimizing uncertainty pp. 611-612, and ease of use and understanding p. 604. The Product and Patent Search revealed no comparable product or method. Recent U.S. Pat. No. 10,664,777 “Automated recommendation for task automation” considerations involved initial input from workflow results, reliance on machine learning, and resultant determination whether to automate a workflow task such as a human resource task in workflow. The invention's forecasting method does not use machine learning or restriction to recommend automation of task(s). In other instances of predictive nature, distinction of ‘task’ in an operating system and application software in context, may apply. An operating system (OS), as the layer between hardware and application software, directs OS ‘tasks’ such as machine needs more power. Application software, as the layer between OS and user, more aptly directs software ‘tasks’ equating to activity such as production needs more cars.

Methods surveyed also included review of reporting that assists evaluations, analysis, or interpretations by templates, computer dashboards, static reports, and dynamic reports. A ‘template’ was found to be a preset format of a non-populated document or file routinely limited to a single or special function (inventory list, monthly budget, attendance report, etc) used or inserted from an external source and not reconstructed each time. A computer ‘dashboard’ was found to be a composite graphic representation of user-relevant summaries created from “reports”. Datapine .com's “Static vs. Dynamic Reports” distinguishes ‘static’ from ‘dynamic’ reports: “A static report offers a snapshot of trends, data, and information over a predetermined period . . . relating to a specific area of business” but “Dynamic (or real time) reports offer 24/7 access to the most up to date information while enabling the user to interact with data through functionalities such as interactive features and other capabilities . . . As a result of their interactive nature, dynamic reporting dashboards also help businesses become more responsive to unexpected issues or sudden changes”. It further states that static reporting is more time consuming pulling up “multiple reports from different sources” whereby dynamic reporting “consolidates relevant data in a central location”, and “Static data provides value for a short time . . . set in stone. However, interactive reports are customizable both in terms of content and functionality . . . allowing you to remain responsive to the . . . landscape around you”.

### b. Problems Involved

Recent effects of the 2020-21 pandemic has changed how businesses, groups, or individuals conduct affairs and interact. Virtually self-employed render ‘strategy’ as no longer strictly confined to top management in the traditional sense. Strategic management is extremely time consuming—its largest problem. However, strategic management practice routinely has problems in providing a consistent approach and a reliable automated tool that efficiently helps reduce time in formulation, reduce tasks of projecting future resources with impacts' effects, and reduce uncertainty. Models conventionally show ‘what to do’ categories and relationship of factors rather than quantities or metrics for assessment and measure. Open source and commercial templates lack quantifying levels for assessment. In 2019, Steffani Cameron noted three challenges facing strategic management in the 21st Century as anticipating effects of change indicators in technology, environment, and politics (Ref. 2a). With regard to technology, “speed at which technology is progressing has changed everything about life . . . financial challenge of staying current with tech . . . it's not just the advent of technology that is an issue for companies, but it's about how others will use tech to force their competitors' hands”. The challenge posed by environment is anticipating effects of climate change and materials or packaging. That of politics primarily concerns effects of regulation. Chltra Reddy noted disadvantages of complexity, time-consuming process (data requirements, research, interactions, consultations), and difficult implementation where the “implementation process calls for perfect communication among the employees and employer” (Ref. 2b). Asley DiFranza noted three challenges to data analytics as need for more trained professionals, bridging gap between executives and predictive analysis explanations (Ref. 2e). The invention's structure through preprogramming and areas of interest overcome spreadsheet shortcomings regarding business concepts, another analysis in same set of data, and multidimensional data capability (Ref. 7). Universally end-result qualitative projection index factors and technology impact factors address some challenges noted above.

Productivity applications surveyed found office suites, tracking, task management (Toggl, mobile apps), workflow (Asana), team messaging (Slack), video conferencing (Zoom, Skype), project management (Soho), and requirements in time to construct using external apps and third party services (Podio). Some problematic matters found in productivity apps generally are: limitation to a single function, operation, or team restricting utility; absence of automatic refinement affecting time and cost; and limited operation and access by unskilled. As related to the general planning process, the productivity applications (1) lacked efficiency from automatic refinement reducing time involved in interactive reporting and allowing real-time assessment of changes impacting environs relevant to alternative review and implementation, and (2) lacked efficient data maintenance in problem definition, alternative review, and implementation. A more efficient digital structure with unique capabilities and features solve some operational limitations. It further enhances time-cost efficiency and effectiveness of long-term sustainable solutions that affect desired outcomes. Forecasting operational or functional environs considering mutual benefits increases sustainability.

Strategic planning products are short term and only tell the enterprise where to place attention. Strategic management involves short to long term stages and determines what action the user will take and how. The former ends with status of plans while the latter ends with control and overall direction of resources. The invention and strategic planning products both are dynamic, can customize dashboards, can use connectivity with diverse collaboration apps or cloud-based access, have quantifiable measures, use real-time updates, and are capable of SME and LE use. Computer dashboards are created by detailed reports. Charts and graphs alone do not give details at the operations or staff level indicating stability. The invention's uniform Plans structure does. Further, the invention solves major common problems noted in strategic planning with uniform formatting and coding, managing multiple plans across the enterprise, showing a bigger picture, and giving the “why” and “how” (Ref. 7). More specifically, Abhisek Kapoor noted problems of multiple managers and multiple forecasting approaches being a lack of uniformity—a common tool for comparable forecasts and a common set of assumptions (Ref. 7). This can affect reliability of the dashboards. The Planview™ product (requiring a set of programs) for example, has business-centric critical success factors; the invention has universally end-result qualitative factors in its forecasting (some have anticipated many effects of current social media and pandemic). Unlike the invention, these products lack capability in the same program to provide consistency in approaches, to centrally view all 24/7 real-time interactive reports offline or online rather than from external sources or modules, and to retain focus of all interactive plans' detail with an organization's or user's overall strategy.

Their automatic operational updates significantly differ from the invention's automatic refinement sequence. The automatic refinement gives updated stages of reports and analytical framework's necessities and impacts based on automatic updates of forecast factors—a broader capability. Operationally, it automatically refines multiple forecasts upon each change displaying real-time YTD status in view of the long-range perspective. This reduces frequency of interactive reassessments, increases control of all plans' detail and logistics, and indicates levels requiring reprioritizations of resources for control and execution stages of the strategy without reinitialization. Exemplarily, a self-serving preoccupation with competitive position, profit, or productivity in strategic planning products excludes consideration of interdependencies or mutual benefit with those the strategy affects—a long-range perspective. Exclusion of such considerations as impacts in assessments of environments can be problematic to sustained performance and effectiveness. The invention's structure with capability to forecast overall necessities and technological and crisis management impacts helps resolve this oversight. Additionally, structural inadequacies affect data integrity regarding accuracy and efficiency in problem definition, forecasting, and implementation. A lack of uniformity Kapoor mentions increases operational difficulty and uncertainty. Solutions to technical needs of uniformity, operational difficulty, data maintenance, and uncertainty are required. Automatic refinements solve some of this.

The current search also reveals forecasting software of: (1) new or extended application software; (2) software suites (collection of two or more computer programs usually application software); (3) deployment on premises (client server) or cloud-based business systems with technical support or customer service; (4) specializations to a single financial application for a wide variety of industries such as accounting solutions or SCM demand planning; (5) artificial intelligence-based forecasting (AI) such as IBM's Cognos TM1; (6) lack of combined forecasts in the same application for better accuracy; (7) use of sophisticated statistical methods in forecasting; (8) lack of cross-functionality capability in most standalone application software to perform non-financial applications (energy, land use, scientific-medical-engineering, social services, etc.) plus financial applications (financial management, accounting, budgeting, etc.)—from proprietorships to C Corporations as well as unregistered groups or registered organizations of committees to religious entities to international organizations where Vena Solutions and Acumatica exemplify this lack; (9) lack of real-time user interface of readjustment in priorities or alternatives without reactivation; (10) lack of supplementing KPIs with data for predicting future conditions impacting aspirations (goals, objectives, mission) such as effectiveness of intercultural programs, youth development, or land use mix (non-financial) as opposed to financial real estate development; and (11) cost-prohibitive availability for many students even with software as a service (SaaS). As related to the forecasting process, general characteristics (3)-(4), (6)-(8) of forecasting software noted consume a considerable amount of time, staff, and costs involving evaluation and analysis.

Average file size is important to disk space, rate of power consumption, and time to fully function or focus on content. The invention's workbook as coded before data is 8.24 MB. By using the percentage of an Excel® mobile worksheet to an Excel® desktop worksheet (88.22%), a blank invention mobile workbook would be estimated as 7.27 MB. Sweetpricing.com reports average file size of a blank iOS mobile productivity category approximates 25 MB (Ref. 8). Using this as a benchmark, a blank invention mobile file size as estimated is 70.92% less than the average iOS productivity app and 51.53% less than overall Android apps. On this basis, the invention should use less power and function more efficiently than other forecasting software or productivity apps.

Strategic management requires solutions to technical needs of less operational difficulty, better data maintenance, and less uncertainty (where these 3 required solutions collectively embody “operational efficiency”) for improvements. Forecasting software as ‘any other technology’ requires solutions to technical needs of integration of forecasting and planning, minimizing uncertainty, a wider ease of use and understanding (“simplicity”, “layperson's language”) towards better analysis, accuracy, and cost-efficiency for improvements. Alignment of capabilities and features with their improvements to strategic management practice at each step in the process is noted in the detailed description section.

### BRIEF SUMMARY OF INVENTION

The invention forecasts operational or functional environs for better strategies, decisions, mutual benefits, and sustainability. Functionally, the invention streamlines strategic management practices. It is an innovative full-fledged forecasting application software, as an independent standalone computer application, having operational efficiency and greater effectiveness. As such, it enables reduced time and cost in formulation (issues, goals), alternative review (impacts, changes, conditions, priorities), and implementation (actions, assessment, control, adjustments). Structurally, it is designed to maintain beneficial aspects or results to human conditions. The universally end-result factors of the qualitative projection index and the needs and impacts in the Analytical Framework better assure this. This is by design. Cognizably, convenience and portability established many PC functionalities in smartphones as innovations. Similarly, “convenience” as applied to this invention has 14 embodiments of which 7 are unique. Combined with solutions to the technical needs of forecasting software and to efficiency in strategic management practices are significant innovations in the art.

The innovative sequence of source coding enables capabilities of simple mathematical techniques throughout in a standalone application. This helps solve data maintenance, operational difficulty, ease of understanding, and cost of system integration. For example, social and technological change factors embodied in the qualitative projection index combined with the automatic refinement algorithm sequence recognize a rate of changing environs that affect availability of finite resources. Pre-programmed features (customizable forecast horizons, real-time YTD actual time series, automatic multiple forecasts refinement, etc.) help solve operational and analytical difficulties embodied in the user-chosen ‘areas of interest’.

Format and structure of multiple strategy or planning areas with 10 elements each enable long term simultaneous assessment of multiple approaches (PESTLE has 6, SWOT has 4, benchmarking has comparatives, etc.) with multidimensional factors contribute to a uniform approach in practice and has greater reliability from multiple forecasts. Preprogrammed and structural design provide advantages in forecasting software and strategic management operations of: (1) customizable forecast horizons that can expand functionality to research through conversion (nanoseconds to hrs, etc); (2) simple operation for user(s) without technical knowledge or skill; (3) automatic refinement of multiple forecasts; (4) accuracy check to prevent inadvertent data entry error differing from data validation; (5) uniform and quick offline or online visibility of up to 32 Plans' minute details for review, implementation, accountability, control, and adjustment more efficiently, (6) uniform quantifiable common assumptions and aspirations retaining focus among multiple users' approaches; (7) integration of all plans with common aspirations and long term strategies; (8) revisable alternatives, priorities, and internal relevant information references enabling reevaluation without reactivation; (9) allowing automated consideration of often-forgot interdependencies with those the user's strategy affects through the Analytical Framework's impacts: (10) eliminated need for technical support, customer service, or consulting services; (11) comprehensive budget detail and necessities giving better anticipation of resource availability over a long term; (12) less storage required comparably; (13) greater operational time and cost efficiency; and (14) more cost-efficient than SaaS. Advantages (2)-(3), (5)-(8), (11), and (13) provide a greater increase in productivity. These advantages in combination further reaffirm significance of the embodiments of convenience as innovations.

The invention's preprogrammed structure provides uniformity in formats, data preparation, reporting, prioritizing, and assumptions that help retain the focus on goals and determine the overall direction of the enterprise over the long term. Productivity and strategic planning apps lack this. Its settings and selection of areas of interest reduce complexities of issues and interrelationships. The automatic two forecast reports refinement after each change gives real-time YTD status of overall goals, conditions, impacts, and monitor for control. This is expressed in the Forecast Overview, Analytical Framework and Plans detail. Preconstructed design of Plans 1-32 enhances the ability to handle new developments in real time (financial controls, alternatives, rescheduling), reprioritize its elements, and integrate plana into one vision or mission. Structure also enables more efficient productivity, quality time, and cost reduction. Convention planning exemplarily demonstrates this capability. Combination of the Plans, unique Analytical Framework (FIG. 14), internal relational database, allocations of goals and objectives (priorities), ancillary Comprehensive Budget, and Program Highlights expressing actions that will be taken culminate in a strategic means to accomplish. This overall effect is neither similarly structured nor readily available in existing forecasting software or strategic applications for the user (SMEs, LEs, and the average person). As such, the structural design in the same program overall has not been predicted. Time and cost invested, ease of understanding and use, and availability are improved.

In combination, these solutions provide advantages in productivity, convenience, and improvements of integrating forecasting with planning, lessening uncertainty, ease of use and understanding, universal utility in strategic management or planning, and cost-efficiency. Context here indicates that improvements to functioning of forecasting technology are achieved through forecasting software; and improvements to strategic management practices are achieved in part through productivity applications or strategy planning products.

### BRIEF DESCRIPTION OF DRAWING VIEWS

FIG. 1 is a block flow diagram at 76% of original depicting an overview of the invention's sequence of steps and introduction to the resultant product.

FIGS. 2-4, 6-6A, 9, 12 are block flow diagrams depicting 24 steps in the automatic refinement algorithm sequence detailed as Instructions 3-6, 7-10, 11-15, 22-25, 30b, and 36b-c of the computer program listing (CPL) involving formation and structure for simultaneous multiple updates of the midrange and long-range forecast factors through the data entry activation in initialization which starts operation.

FIGS. 2-3A are block flow diagrams depicting steps in formulation of the forecast factors.

FIGS. 3-9 are block flow diagrams depicting steps in formats embodied in structural design that enable designated capabilities and features, improvements, unique reports, and the utilities.

FIGS. 9-12 are block flow diagrams depicting steps in initialization of entry settings through data entry activation and internal references for help.

FIG. 13 is a black and white screenshot of the print view of a blank Forecast Overview visually disclosing structure of aspirations/priorities (goals, objectives, mission), projected balance, activity/data report with real-time reset of priorities.

FIG. 14 is a black and white screenshot of the print view showing that part of the Analytical Framework on Sheet 7 which includes yearly forecasts adjusted with % error, impacts, and graphic areas for dashboards with the other part shown in FIGS. 7, 8-9 as Information Resources.

FIG. 15 is a black and white screenshot of top of the Intro worksheet at 69% of original visually disclosing advantages, special features, users, sampling in range of functions and applications, and portion of access map.

### DETAILED DESCRIPTION OF INVENTION

The Specification, Claims, drawings, computer program listing appendix (CPL), and Appendix to the Declaration including References and dates of derivation (ADecl) provide full disclosure of the invention. The invention reduces time-consuming and difficult operations throughout strategic management ending with control, adaptability, and iterative readjustment for effective implementation and sustainability in the same program. As a whole, it is a full-fledged forecasting software product prepared by the sequence of processes that enable improvements and a wider utility in strategic or planning areas being easier to use and understandable by non-technical or unskilled individuals, groups, teams, etc. It is documented that full-fledged computer applications can be written with Excel® as a platform (Refs. 4-5).

Steps depicted by the drawings and proprietary coding of the CPL enable anyone authorized to code the invention to make and use it. Shading in the black and white drawings indicate innovations or not in common use or solutions and improvements in existing technology or technical field of practice. In combination, the shadings can also represent the solution and improvement of ‘convenience’. “Convenience” here are the 14 embodiments in this single standalone computer application designated as: (1) added control and security in a single tool designed for offline capability with minimal macros; (2) customized forecast horizons; (3) qualitative projection index; (4) data maintenance simplicity; (5) uniform forecast structure solving problem of multiple manger different methods; (6) automatic multiple forecasts refinement enhancing adaptability; (7) visibility of side-by-side mid- and long-range forecasts simultaneously computed for multiple strategic or planning areas; (8) real-time revision of alternatives or priorities; (9) reevaluations without reactivation; (10) customized dashboards; (11) internal relational databases augmenting analysis and data storage; (12) ease in settings for non-technical or unskilled full operation; (13) comparably less storage required; and (14) greater forecasting and strategic functionalities.

The formulation process (paragraphs 44-47) begins the development sequence. It includes enablement of platform options/worksheets and formulation of forecast factors including formulas. Enablement involves setting maximum iterations, setting toolbar icons, and naming main operative worksheets with specific tab colors. The names and tab colors assist ease of use and understanding. Sheet 2 is designated as “Settings”; Sheet 3 is designated as “Estimated”; Sheets 4-6 are designated as “Plans I”, “Plans II”, and “Plans III” respectively; and Sheet 7 is designated as “Performance”.

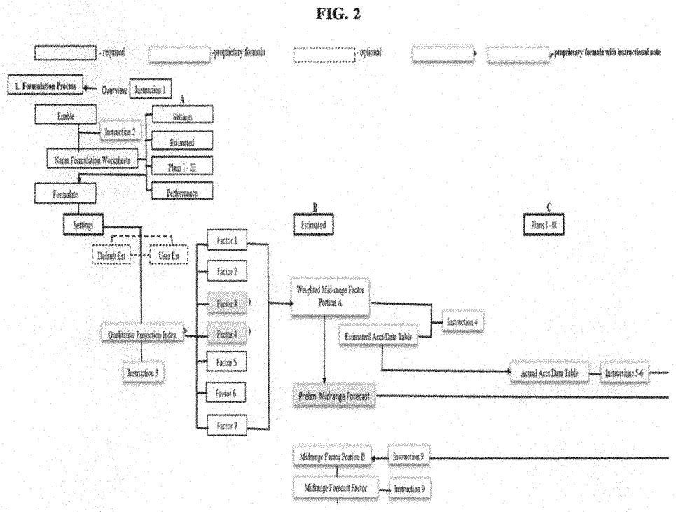

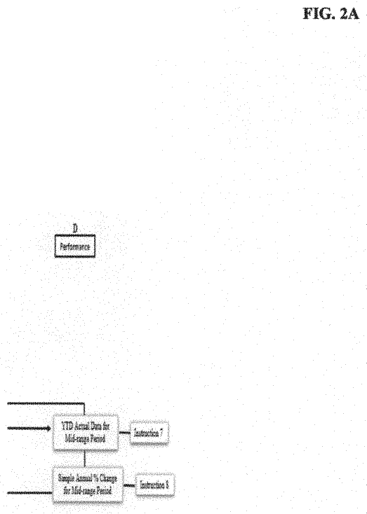

Mathematical simplicity and unique sequence forming the base midrange and long-range forecast factors improve use by non-technical users and base preparation for less uncertainty from automatic multiple forecasts. Embodiments of mathematical simplicity which exclude any complex statistical methods include qualitative factors, real-time actual YTD time series, and simple annual percent change in initial formulation of forecast factors. Formulation of the forecast factors begins with the qualitative projection index consisting of 7 factors in the Settings Worksheet (FIG. 2; Instr. 3). The index's universally end-result qualitative factors such as the social and technological factors better help the user to formulate a vision, identify problems, and anticipate impacts. The option exists to use the default estimates of the qualitative index factors or the user's own. This establishes the 1st part (Portion A) of the weighted preliminary base midrange forecast factor as percentages (FIG. 2; Instr. 4a). The top of the Estimated Worksheet is reserved for a Table of the user's subsequent estimated or existing data entry (FIG. 2; Instr. 4b). A similar Table is set at the top of the Plans I Worksheet with coding for matching actual data of Plans 1-32 with corresponding estimated data from the Estimated Worksheet (FIG. 2; Instrs. 5-6). This in turn establishes the actual data monthly and yearly time series YTD coding before activation in the Performance Worksheet. The time series data is to serve as the source for the simple annual percent change of the midrange periods in the Performance and Estimated Worksheets (FIG. 2A; Instrs. 7-8).

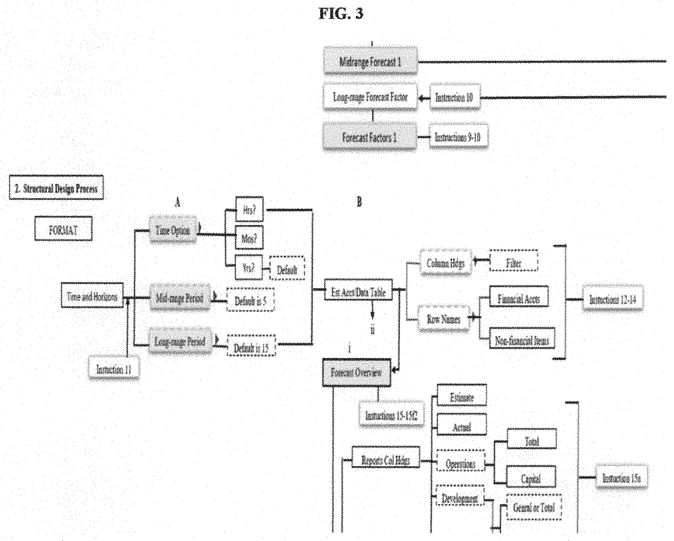

The 2nd part (Portion B) of the midrange forecast factor results from this sequence (FIGS. 2, 3; Instr. 9). The 1st and 2nd parts of the midrange forecast factor (Portions A and B) combined form the base midrange forecast factor 1 (FIG. 3; Instr. 9). The base long-range forecast factor is established from the base midrange forecast factor 1 (FIGS. 3A, 3; Instr. 10) together forming base forecast factors 1.

Embodiments of the first 8 steps in the automatic refinement algorithm sequence are specified in the formulation process as (1) qualitative projection index, (2) preliminary base midrange forecast factor, (3) formulation of Estimated account/data table, (4) formulation of actual data match, (5) formulation of Actual YTD time series, (6) simple annual percent change, (7) base midrange forecast factor 1, and (8) base long-range forecast factor 1. References are: Instr. 3 for (1), Instr. 4 for (2), Instr. 4 for (3), Instrs. 5-6 for (4), Instr. 7 for (5), Instr. 8 for (6), Instr. 9 for (7), and Instr. 10 for (8).

The structural design process (paragraphs 48-65) provides the formats for improvements, unique reports, and utilities. It is dependent upon the formulation of forecast factors used throughout the structure. The process begins with time and horizon options of hours, months, or years and customizable length of midrange and long-range horizons in the Settings Worksheet. The defaults are: years, 5 for midrange, and 15 for long-range (FIG. 3; Instr. 11); and maximums of 60 months or 43,830 hours for midrange and 180 months or 131,490 hours for long-range. Formats for the Estimated account/data table in the Estimated Worksheet are necessary for all reports which include existing or estimated data. These formats include unlocked cells, filters, financial or non-financial column and row names (preset account or user-defined item), fonts, “areas of interest” category columns (FIG. 3; Instrs. 12-14). The color scheme applying to the Forecast Overview and Category or Fund Report is intended to render the structure easier to understand. The user may select “Bright Color Shading” or more subdued shading (FIG. 3, Instr. 15). The Forecast Overview, Category or Fund Report, Comprehensive Budget, and Scheduling Report are on the Estimated Worksheet and each has a separate print view (paragraphs 49-55).

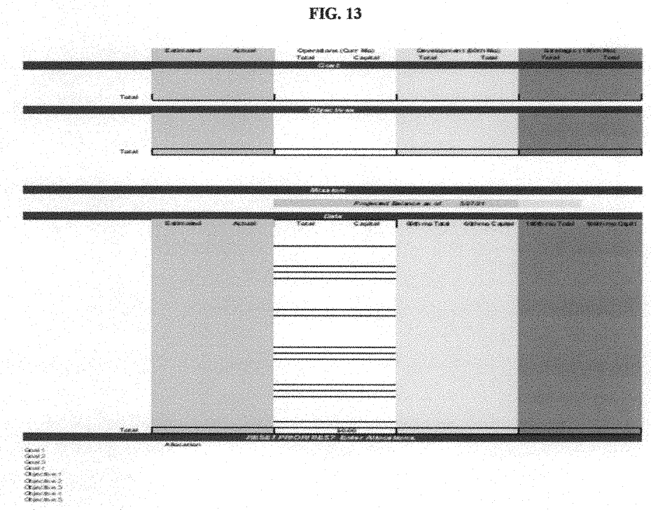

Format structure for the Forecast Overview (paragraphs 49-50) has an optional aspirations portion and required activity/data report portion. Each involves side-by-side columns for operations (current), development (midrange), and strategic (long-range) forecasts. It helps issue recognition and alternative review stages giving insight on goals, priorities, and other elements. The Overview provides innovations in combination of: allocated aspirations or priorities expressed as goals and objectives in text; and activity/data reports having forecasted operations-development-strategic stages to be populated by the account/data table rows and columns for the unit-function-demand area(s) applied. This portion has capability for real-time resetting of priorities (FIGS. 3, 4, 13; Instr. 15). Some elements of the Overview originated from the 1995 planning framework (ADecl pp. 5-6, 18). Depicting aspirations as the user's priorities helps solve the problem Abhishek Kapoor noted regarding business forecasting. The Overview has columns for operations, development, and strategic stages forecasted side-by-side concatenated with the user's chosen time horizons and allocations. The aspirations' area sub columns concatenated to time horizons are titled “Total” and “Capital” (non-financial mode) and “General” and “Capital” (financial mode). The “Estimated” (non-financial mode) or “Budgeted” (financial mode) and “Actual” columns do not have sub columns. A total projected balance as of date is structured after the aspirations area and before the activity/data report portion.

Data for the account/data report is structured to come from the Estimated account/data table—a table with rows containing 32 full names of user-chosen area(s) of interest with up to 10 applicable elements for each name (FIG. 3; Instr. 12-14). The account/data report portion is not optional. Its rows are structured to contain full names of the area(s) of interest to be chosen and has columns the same as those mentioned above. Its data for Estimated and Actual rows is to subsequently come from the total of each account/data table column. The report's multiple rows are sufficient to simultaneously enable assessment of factors in multiple strategic management approaches (PESTLE, SWOT, benchmarking, etc) plus planning areas (9 major climactic areas, units, functions, or demands) minimizing operations involving alternative review and choosing course of actions. It is also structured such that real-time revisions in the Overview based on spontaneous outputs without reactivation, as opposed to preset requirements of scenarios, are possible. The Overview's section in non-financial mode permitting real-time reset of the user's priorities by changing allocations of goals and objectives, if present, provides this. Such structure and capability of contents are not customarily found in forecasting software or strategic planning products. The Forecast Overview report can be used to create a user-opted computer dashboard (Comment at each chart area in the Performance Worksheet instructs on how to do this).

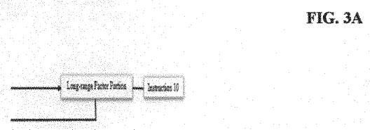

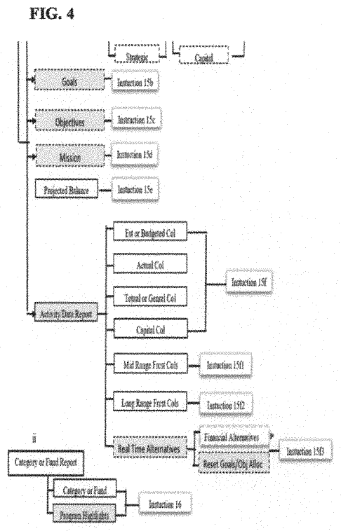

Format structure for the Category or Fund Report has a category or fund information portion and program highlights portion. The category or fund portion is not optional; the program highlights portion is optional. Its data for Estimated and Actual rows is to subsequently come from the total of each account/data table row. Column headings for the category or fund information portion are “Estimated” or “Budgeted” (as noted above), “Actual”, and those concatenated with user-chosen time horizons of “Operations”, “Development”, and “Strategic” such as “Development (4th mo)”. Sub columns are “Estim Total”, “Actual Total” and as noted above for “Total” or “General”. Category or fund information rows are structured to contain user-chosen item categories (non-financial mode) or default account categories (financial mode) from the account/data table (FIG. 4, Instr. 16). The program highlights portion (Instr. 16) expresses the short-long term direction decided upon indicating a roadmap for implementation. It achieves this by stating actions that will be taken in the current to long-range periods for operations and capital combined with status regarding taxes, audit, and authorization. This report can be used on the front page of annual reports or to create a user-opted computer dashboard as noted above.

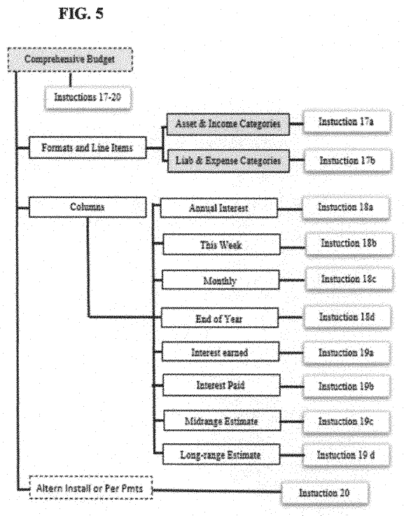

Format structure for the optional automated Comprehensive Budget (paragraphs 52-54) is designed to enter alternatives' data first (paragraph 54) and has unique line-item category combinations forecasted for a longer planning perspective. As an ancillary to the Forecast Overview, Category or Fund Report, and Analytical Framework, it indicates practical financial abilities to implement and sustain actions for effectiveness within forecasted conditions reported. Preconstructed fixed line-item categories combining assets (annuity, loans made, other—contracts, stocks, etc.), income (pay, rental income, etc.), liabilities (mortgage, postal box rent, etc.), and expenses (food, computer equipment, etc.) in same financial application are unique and more efficient. It eliminates the need to recompute total amounts for different types of financial reports in specific formats each time. Customarily, account assets-liabilities and budget income-expenses are in separate applications. Such row names of line-item categories as annuity payout, gifts and property acquired (summing assets including intangible property such as value of intellectual property), credit available, real estate transactions, medications, range of insurances, entertainment events, travel costs, and credit usage extend beyond single traditional budget templates (FIG. 5, Instr. 17a-b). Its columns make it more significant also.

Column names of “Annual Interest”, “This Week”, “Monthly”, and “End of Year” format a basic idea of status and operations (FIG. 5, Instr. 18). However, column names of “Interest Earned”, “Interest Paid”, and midrange “Est” and long-range “Est” concatenated to chosen time horizons format a longer planning perspective than traditional budget or financial templates (FIG. 5, Instr. 19).

The alternatives' columns beneath the line-item categories are formatted and coded for “Annual Interest”, “# of periods,np”, “amount,A”, “payments,PMT”, “yr-end total”, “accrued(bal)”, and “np til end of yr”. Interest rates for installment or periodic payments of annuity payout, savings, loans, investments (mortgages, etc), and up to 3 credit cards (FIG. 5, Instr. 20) in this section allow for applying real-time alternatives without reentering line-item(s). As structured, it is time-cost efficient.

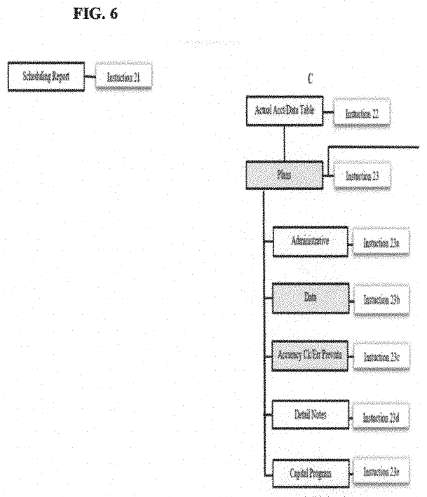

Format structure for the Scheduling Report provides the increases, decreases, total and scheduled dates with resources subsequently populated from Plans 1-III Worksheets and indicated for each unit, function, or demand row name the user will choose (FIG. 6, Instr. 21). It is an ancillary that helps the user best align and control resources for implementation.

Formats for the Actual account/data table at the top of the Plans I Worksheet are necessary for all reports which include actual data. The names of rows and columns are the same as those in the Estimated account/data table. The Actual account/data table is coded for matching the actual data of Plans 1-32 with the corresponding estimated data filtered from the Estimated Worksheet (FIG. 6, Instr. 22).

Formats for printable Plans 1-32 in Plans I-III Worksheets include administrative, data, accuracy check, detailed notes, and capital budget sections. Plans 1-32 provide minute details and logistics helping to handle new developments, prioritize each element in the Plan, retain focus, and provide 24/7 visibility for alternatives review, control levels, and adjustment. Each Plan is an activity, program, project, event, or system. The administrative section permits the user to specify officers, members, and sponsors (or partners) of each activity or work group. The unique data section provides structural design for objective of the activity, filtered Estimated row name with its budgeted or estimated quantity, actual data, quantity due as of date, weight assigned to each row, and estimated midrange total for each row (FIG. 6, Instr. 23b). The structured format for an accuracy check is a unique feature improving data integrity by helping to prevent inadvertent data entry errors not subject to data validation or comments such as transcription errors or fixed to remain unchanged (FIG. 6, Instr. 23c). It includes the unique feature of being able to designate which data.is to remain unchanged or “Stays Same” (FIG. 6, Instr. 23b, Instr 23c)—such as use with financial controls indicating approval of expenditures, disbursements, etc. Detailed notes include the available default resource database or user's own (FIG. 6, Instr. 23d), projected balance as of date, and information regarding the associated capital budget's line items—from assessments, donations, property inventory or sales (FIG. 6, Instr. 23d). The capital budget's line items to be automatically populated from the Estimated account/data table showing status culminates complete presentment of each activity, plan, program, project or system element (social, political, economic, environmental, etc) (FIG. 6, Instr. 23e). Utility of the 90 day calendar (paragraph 63) accessed from the Name Box after the initialization process supplements plan preparation schedules.

Format structure taking actual data from Plans I Worksheet entered in real-time into the YTD time series in the Performance Worksheet (FIG. 6A, Instr. 24) initiates the unique Analytical Framework.

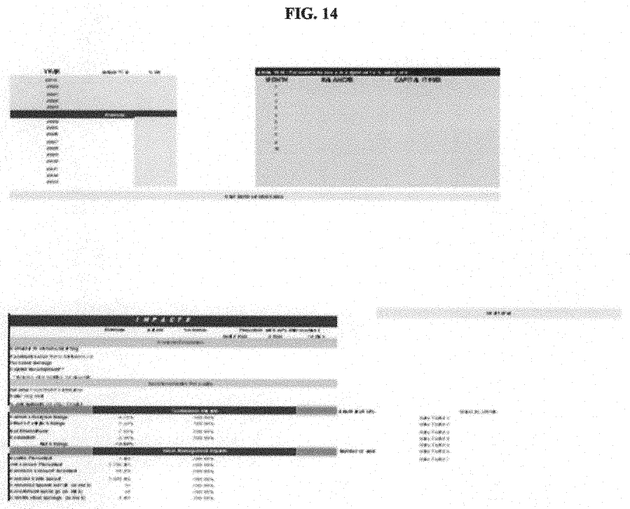

Format structure for the unique printable Analytical Framework (paragraphs 59-61) in the Performance Worksheet (FIG. 14) provides short-long term levels for the evaluation stage and conditions impacting environments in implementation. It includes yearly and customized period forecasts adjusted with percent error and impacts section. Yearly forecasts are coded for up to a 15-year period with the first 5 years deriving from the actual YTD cumulative time series (FIG. 6A, Instr. 25a). Percent changes in this period are by 1st Qtr, 2nd Qtr, or annual for the specific year. Estimates coded for the next 10 years derive from one-tenth of forecasts made in the Estimated Worksheet starting with addition of the 5th year in first 5 years actual YTD time series to Estimated Worksheet's forecasts (FIG. 6A, Instr. 25a). These 10-year estimates can be cumulatively updated from each 5-year period. Percent change between the Estimated Worksheet's forecasts and Performance Worksheet's yearly forecasts is coded (FIG. 6A, Instr. 25a). Raw yearly forecasts are shown in this portion. The adjacent portion however shows what customized time-horizon forecasts look like without the actual percent error helping reduce the level of uncertainty. A percent error greater than or equal to 10% suggests “Review Estimates & Info Res” indicating that the user should revaluate the basis of estimated data without reactivation. These forecasts are shown in columns for user-chosen time period (hours, months, years) up to its maximum horizon, titled “BALANCES”, and “CAPITAL ITEMS” (FIG. 6A, Instr. 25b). A user-defined graphic chart area is provided also (FIG. 6A, Instr. 25) and can be used to create a user-opted dashboard.

The Framework's optional impact section (paragraphs 60-61) provides needs and impacts of technology and crisis management helping to serve as an indication of future operating or functional environments. Columns for the impact section are structured for “Estimate”, “Actual”, “% Change”, and “Projection with 2% Improvement” having sub columns of one-half the midrange time period chosen, midrange time period, and long-range time period. The needs portion is structured with “Domestic Economies” and “Basic Necessities Per Capita” for data to subsequently be inputted from the Settings Worksheet (FIG. 6A, Instr. 26). The Domestic Economies has rows for workforce, recipients, savings, capital development (FIG. 6A, Instr. 26a) and its factors were derived from the 1978 copyright and 1994 full employment plan (ADecl pp. 10; 15, 17). Basic Necessities has rows for food/water, housing units, job subsidy for under a 94% employment level (FIG. 6A, Instr. 26b) and its factors were derived from the 1978 copyright and 2005 national disaster relief mockup (ADecl pp. 10, 21). A user-defined graphic chart area is provided also applicable as part of an optional dashboard

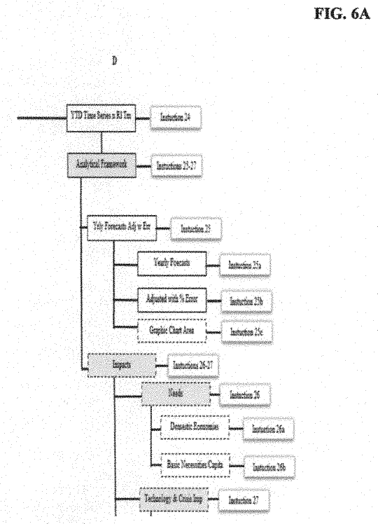

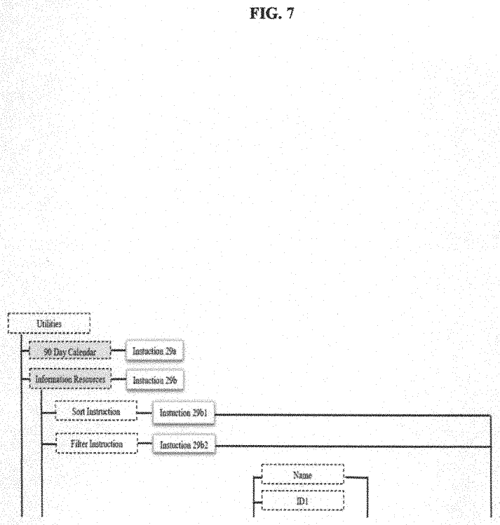

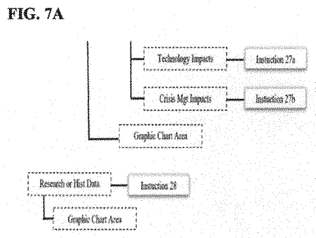

The technology and crisis impact portion is structured with “Technology Impacts” and “Crisis Management Impacts” (FIGS. 6A, 7A; Instr. 27). Technology Impacts were derived from the 1983/93 technology limits and 1987 risks of RF (Adecl pp. 12-13). It has rows for human lifestyle change, other lifestyle change, net employment, and regulatory with the Actual column populated from actual current period numbers of the index factors such as actual current number from percent change in market and growth base, etc (FIG. 7A, Instr. 27a); ADecl p. 12). This option is structured to simplify determining the social and technological change factors (index factors 3 and 4) for a user(s) through use of the UN's ITU Annual Report and various accessible data sources (Instr. 27a). Crisis Management Impacts were derived from the 2005 national disaster relief mockup (ADecl pp. 19-21). It has rows for deaths prevented, job losses prevented, business losses prevented, housing units saved, consumer spending/100 (FIG. 7A, Instr. 27b, ADecl p. 21), government savings, and construction savings (Instr. 27b). This option is structured and coded for data to come from the Settings Worksheet.

Format structure for the printable optional Research and Comparative or Historical Data report in the Performance Worksheet provides a summary of user-chosen research or comparative and historical data for 6 default measures or 6 user-customized measures and 32 rows (FIG. 7A, Instr. 28). The 6 default measures are “Number”, “Quantity”, “Group”, “Unit Cost”, “Time”, and “Distance”. It is subsequently populated from Settings Worksheet data and ancillary to the Plans Worksheets and Analytical Framework. As such, data in this report are used for reference and not in computing the forecasts. The report's heading gives the year, an interchangeable title identifying as “Research Data” or “Comparative or Historical Data”, and an instruction for use of scientific notation. A user-defined graphic chart area is provided also applicable as part of an optional dashboard (Instr. 28).

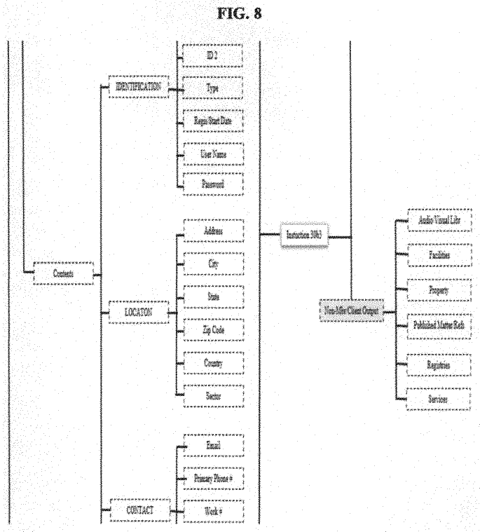

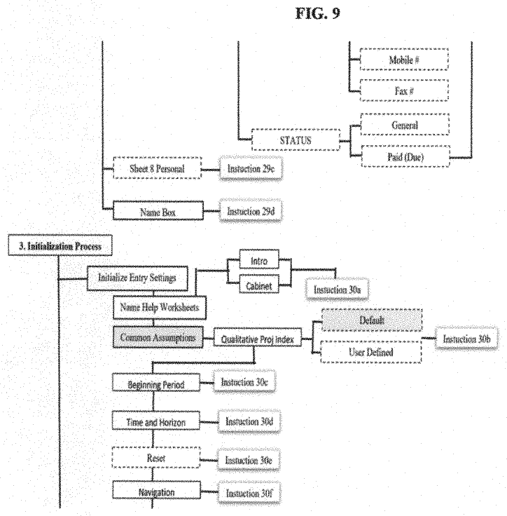

Format structure for Utilities (paragraphs 63-64) includes the 90-day Calendar, printable Information Resources in the Settings Worksheet, and Name Box workbook wide. The 90-day Calendar is formatted to display 45 days before and 45 days after whichever date the user enters after Dec. 31, 1929, (FIG. 8, Instr. 29a) and is ancillary to the Plans Worksheets. The Information Resources is formatted to provide internal relational databases supplementarily from non-sequential entries of a wide variety of outputs (FIGS. 7, 8-9; Instr 29b). It is for consultative purposes and is ancillary to the Analytical Framework. Structurally it includes a sort instruction (Instr. 29b1); filter instruction (Instr. 29b2); and contents (Instr. 29b3). The contents have column groupings for “IDENTIFICATION”, “LOCATION”, “CONTACT”, and “STATUS”. Identification has 7 sub columns where “Type” (published matter or articles, URLs, facilities, A/V library, property, services, registries, etc.) may be most useful for sorting purposes. Location has 6 routine sub columns where “Country” and “Sector” may be more useful. Contact has 5 routine sub columns. Status has 2 sub columns for “General” and “Paid (Due)”. Each filtered list can be copied and printed to assist analytical purposes (FIG. 9; Instr. 29c). The Information Resources utility has the unique feature of providing a relational database internally without requiring an external source. This increases productivity being immediately accessible and complementing multidimensional analysis. It is also easy to use, maintain, and understand.

Format structure for the Name Box throughout the Workbook instantly navigates to that location defined in the Workbook. These names include: “ComprBudget”, “Dates”, “Definitions”, “Examples”, “Filter”, “Flt”, “FltB” through “FltzzAG”, “GoalNames”, “InfoRes”, “Navigation”, “ObjectiveNames”, “SecurityMeas”, and “StoreInstruction”. The “Dates” name navigates to the 90 Day Calendar utility. All names are accessible to unhidden rows. This utility saves time and is easy to use.

Embodiments of the central 7 steps in the automatic refinement algorithm sequence are specified in the structural design process as (1) selection of time-horizon periods, (2) Estimated account/data table format, (3) Forecast Overview, (4) Actual account/data table format, (5) actual time series data, (6) yearly forecasts, and (7) analytical evaluation or reassessment. References are Instr. 11 for (1), Instrs. 12-14 for (2), Instr. 15 for (3), Instr. 22 for (4), Instr. 24 for (5), Instr. 25a for (6), and Instr. 25 for (7).

The initialization process (paragraphs 66-82) in the Settings Worksheet provides the settings for data entry, allocations, areas of interest, aspirations, other features, security measures, and activation. It is dependent upon the structural design. Overall, the settings improve functioning of forecasting software making it easier to use and understand as well as improve strategic management's practices for issue recognition, problem identification, and setting goals. Both are enhanced by convenience and consistency in approach with structure retaining focus. This establishes “operational simplicity” that encompasses a default option in projection index retaining common assumptions throughout, simple mathematical techniques, integrating multiple forecasts, and defining common priorities from allocations for goals and objectives (aspirations).

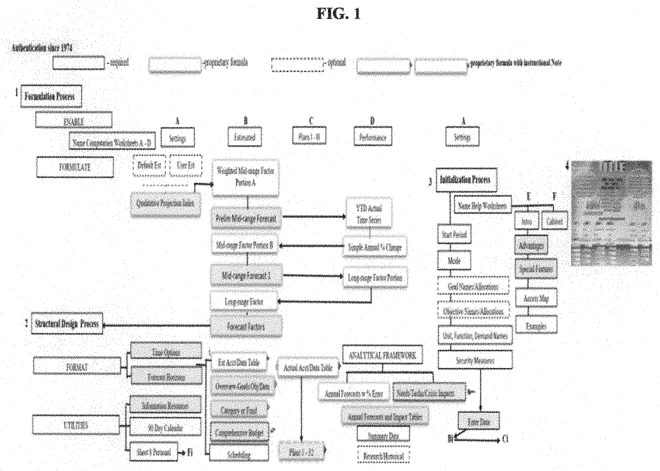

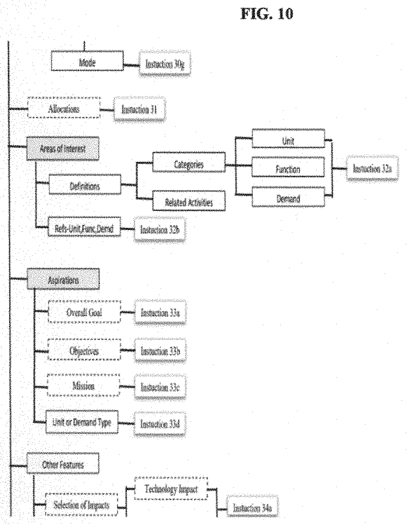

Initialized data entry settings are system-wide and done once even with internal changes to updates or alternatives. They begin with naming Help worksheets to “Intro” as Sheet 1 and “Cabinet” as Sheet 8 to better direct user's applications and assist analytical purposes or visualizations (FIG. 9, Instr. 30a). Qualitative projection index entries by estimate or logical guess on per cent change in 5 years using the default option or user-defined data for the 7 index factors constitute the common assumptions that solve the problem referenced by Abhishek Kapoor in paragraph 17 (FIG. 9, Instr. 30b). A beginning period is entered as a single year (FIG. 9, Instr. 30c). Entries for the time and horizon options are applied to the structural design construct described in paragraph 48 (FIG. 1, Instr. 30d). The Reset option allows the user to clear the entire current application or function (FIG. 9, Instr. 30e). Navigation in an elliptical circle is expedited by the preset graphic of grouped text boxes indexing locations specifically as “Initialization”, “Structure”, “Calendar”, “Security”, “Enter Data” and “Goals/Allocations”, “Objectives/Allocations”, “Attainments Sought” (areas of interest), “Impacts” (FIG. 9, Instr. 30f). It also includes a text box instruction on “Sharing”. Selection of a mode initializes the application as financial or non-financial (FIG. 10, Instr. 30g).

Allocation of optional stated goals and objectives establishes the levels of aspirations. It adds a dimension of priority measure not routinely found in forecasting software or strategic management tools (FIG. 10, Instr. 31). After activation, its Forecast Overview section in non-financial mode permits real-time reset of the user's aspirations or priorities by changing allocations of goals and objectives. The user may choose four goal names and four objective names. A % or proportion for each name is to be assigned as the level of its aspiration.

The areas of interest (paragraphs 69-70) enable cross-functionality with multiple strategic or planning areas, multiple approaches, and integration of plans. Selection of an area(s) may help the user better recognize where an issue or problem exists. They are the basis that initializes the Estimated account/data table, Activity/Data Report, and filtered into Plans I-III Worksheets for matching estimated to actual data. They include definitions and unit, function, or demand references. Definitions are given by category and related activity. “AREA OF INTEREST CATEGORIES” contain designations of a unit, function, or demand (FIG. 10, Instr. 32a lines 1-7). A Unit is defined as a “Department”, “Division”, or “Section”. A function is defined as “use or purpose”, “operation”, “program”, “project”, or “causes”. A demand is defined as “services”, “locations”, “products”, or “parameter”. “RELATED ACTIVITY OF CATEGORY CHOSEN” are designated as “factors”, “tasks”, “operations”, “types”, “sectors”, and “solutions” (FIG. 10, Instr. 32a lines 8-9). This enables capability for multiple strategic or planning areas simultaneously such as unit: HR (intercultural study—elem sch South, secondary sch, etc); function: environmental planning (climate mitigation techniques, land use/selected ecosystem elements); and demand: energy planning (installations by type) exemplarily for culturally sensitive personnel to achieve effectiveness of this research effort.

References for the user-chosen unit, function, or demand are entered as abbreviated names of headings in a designated range of columns and as the full name referenced to the corresponding Estimated Worksheet cell (FIG. 10, Instr. 32b).

Aspirations or priorities (FIG. 10, Instr. 33) are expressed as statements of overall goals (Instr. 33a), objectives (Instr. 33b), mission (Instr. 33c), and type of unit or demand (Instr. 33d) entered. These are optional since they are aligned to allocations. Three objective statements are entered on: “growth or change in demand, clients, customers, or members”, “expansion or contraction in units, function, or demand”, and “capital program” (FIG. 10, Instr. 33b). A type of unit or demand is entered for the title or data name to be expressed for the Forecast Overview such as ‘Program Management’ or ‘Energy Consumption Data’ or ‘Policy Development’ (components or elements of various areas).

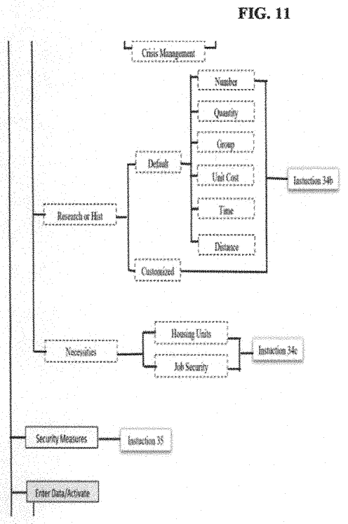

Initialization of optional other features enhance the user's ability to better assess outcomes for greater effectiveness. Other features include selection of impacts, designations for research or historical data reports, and necessities. Selection of impacts include the user option to indicate if a technology impact and or crisis management impact are desired (FIGS. 10-11, Instr. 34a). Settings for the Research and Comparative or Historic report in the Performance Worksheet contain 32 user-chosen rows with data and 6 default column headings of “Number”, “Quantity”, “Group”, “Unit Cost”, “Time”, “Distance” for non-financial applications and “General”, “Capital” for financial applications or 6 user-defined columns (FIG. 11, Instr. 34b). Settings for the necessities in the Performance Worksheet are entry of available per capita data for “Hsg Units” and “Job Security” with notes stating “Enter total housing units from World Almanac or data.un.org” and “Consult the Information Resources list if a data source exists there” respectively (FIG. 11, Instr. 34c).

Settings for the security measures are instructions to password protect the Settings Worksheet through Cabinet Worksheet, Sheet 2-Sheet 8, and subsequently unlock the Estimated Worksheet to unhide its account/data table's designated rows (FIG. 11, Instr. 35).

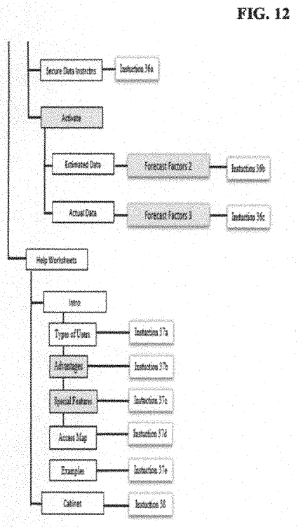

Initializing data entry after activation instructions in the Settings Worksheet include securing data instructions (FIG. 12, Instr. 36a) and activation (FIG. 12, Instrs. 36b-c). Securing data instructions begins with entering user-chosen names in the designated Estimated Worksheet column for non-financial applications or using default names for financial applications. All initial data is entered in the Estimated account/data table. Filter lists for each unit, function, or demand are to be set up using Name Box's FltB-FltzzAG, and the Estimated Worksheet is password protected after its account/data table's rows of data-filled cells are hidden. If more than one user: hide designated columns in Settings Worksheet and specified worksheets (Intro, Plans I-III), set user permission for each plan if using a LAN or make copies of each Plan using original cell locations password protecting each or create each as a database for collaboration, and password protect the worksheet and workbook structure. The last security instruction directs the administrator to unprotect the workbook and unhide worksheets as necessary (FIG. 12, Instr. 36a).

Activation initializes the total operations. It includes entering estimated data in the account/data table of the Estimated Worksheet (FIG. 12, Instr. 36b) and entering actual data, when available, in each Plan matched by account/data table of the Plans I Worksheet (FIG. 12, Instr. 36c).

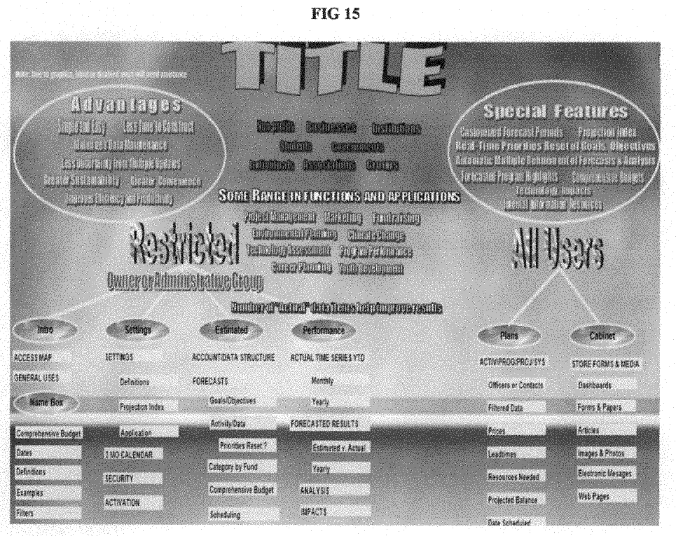

The Help worksheets (paragraphs 76-80) of “Intro” and “Cabinet” in the Settings Work sheet index, guide, and enhance applications (FIG. 12, Instr. 37). The Intro Worksheet (paragraphs 76-79) of general uses and access contains a note on accessibility, title, types of users, sample range of functions and applications, advantages, special features, access map, and examples that ease use and understanding in operation. Types of users denoted are: “Non-profits”, “Businesses”, “Institutions”, “Students”, “Governments”, “Corporations”, “Individuals”, “Associations”, and “Groups”. Sample functions and applications noted are: “Project Management”, “Marketing”, “Fundraising”; “Environmental Planning”, “Climate Change”; “Technology Assessment”, “Program Performance”; “Career Planning”, “Youth Development” (FIG. 12, Instr. 37a; FIG. 15). The Intro Worksheet is password protected and all cells are locked.

Advantages in an elliptical circle are expressed as: “Simple and Easy” and “Less Time to Construct”; “Minimizes Data Maintenance”; “Less Uncertainty with Multiple Updates”; “Greater Sustainability” and “Greater Convenience”; and “Improves Efficiency and Productivity” (FIG. 12, Instr. 37b; FIG. 15). Special features in an elliptical circle are expressed as: “Customized Forecast Periods” and “Projection Index”; “Real Time Priorities Reset of Goals, Objectives”; “Automatic Multiple Refinement of Forecasts & Analysis”; “Forecasted Program Highlights” and “Comprehensive Budgets”; “Technology Impacts”; and “Internal Information Resources” (FIG. 12, Instr. 37c; FIG. 15).

The Access Map has a section for “Restricted” and “All Users”. The Restricted section applies to “Owner or Administrative Group” (FIG. 12, Instr. 37d1; FIG. 15). The elliptical circles under Restricted refer to worksheets “Intro”, “Settings”, “Estimated”, “Performance” as well as the “Name Box”; and major text boxes under Intro are “Access Map” and “General Uses”; those under Settings are “Settings”, “3 Mo Calendar”, “Security”, and “Activation”; those under Estimated are “Account/Data Structure” and “Forecasts”; and those under Performance are “Actual Time Series YTD” and “Forecasted Results” (FIG. 12, Instr. 37d2; FIG. 15 part). The elliptical circles under All Users refer to worksheets “Plans”, and “Cabinet” (FIG. 12, Instr. 37d3; FIG. 15). The major text box under Plans is “Activ/Prog/Proj/Sys”, and that under Cabinet is “Store Forms & Media” (FIG. 12, Instr. 37d4; FIG. 15 part).

Examples on the Intro Worksheet provide instructions and screenshots categorized as “General” including ‘For Multiple Users’ with graphic, “Parental Aide”, “Organizational”, “Business”, “Corporate”, and “Government” to help the user develop appropriate applications (FIG. 12, Instr. 37e).

Setting for the Cabinet Worksheet has 10 print areas and consists of instructions in the Performance Worksheet for storing inserts (computer dashboards, pictures, articles, etc) or created forms in the application to efficiently supplement data or visualizations (FIG. 12, Instr. 38).

Embodiments of the last 9 steps in the automatic refinement algorithm sequence are specified in the initialization process as (1) entering qualitative projection index data and upon activation: (2) entering estimated or budgeted data, (3) updates forecast factors 1 (2nd forecast factors), (4) 1st forecast of reports, (5) entering actual data as available, (6) updates yearly forecasts, (7) updates forecast factors 2 (3rd forecast factors), (8) 2nd forecast of reports, and (9) updates analytical framework without having to reset initial data entry (reactivation). References are Instr. 30b for (1), Instr. 37b for (2), Instrs. 9-10 for (3), Instrs. 15-20, 23, 25-27 for (4), Instr. 37c for (5), Instr. 25a for (6), Instrs. 9-10 for (7), Instrs. 15-20, 23, 25-27 for (8), and Instrs. 25b, 26-27 for (9). This part of the sequence refines to forecast factors 2 and 3.

### Best Mode

User interface on a computer or mobile device is the best mode for using the invention.

1. A preprogrammed full-fledged computer application recorded on a non-transitory computer-readable medium of a commercially available spreadsheet platform for retrieval and visualization given that the application comprises the means for forecasting operational or functional conditions related to the functioning of strategic management that has novel customized forecast periods, automatic multiple forecasts, assessment of field's multiple approaches simultaneously, and comparably smaller file size is created by processes of:
(a) formulating midrange and long-range source-coded forecast factors in the first 8 steps of the automatic refinement algorithm sequence establishing forecast factors 1, having social and technological change factors embodied in a qualitative projection index that retains common assumptions, using other embodiments for mathematical simplicity in forecasting, and making base preparation of automatic multiple forecasts for less uncertainty;
(b) formatting structural design, dependent upon formulation of forecast factors, that includes the 7 central steps of the automatic refinement algorithm sequence and source coding for enablement of solutions and improvements to strategic management practices through combination of the unique Forecasting Overview, Analytical Framework technology impacts, Plans, Program Hieilights, ancillaries, and utilities as well as for improvements to functioning of forecasting technology; and
(c) initializing entry settings and activation, dependent upon the structural design, that includes the last 9 steps of the automatic refinement algorithm sequence refining to forecast factors 2 and 3, reduces complexities, and establishes operational efficiency such that the embodiments of convenience in combination with advantages and solutions to technical needs in uniformity, operational difficulty, data maintenance, integration, uncertainty, and efficiency in the resultant independent standalone computer application improve both the strategic management practices with greater functionalities and functioning of forecasting technology towards desired outcomes with greater reliability in strategies and actions more efficiently than existing tools and easily usable by enterprise, individual, and non-technical levels.

2. A process of claim 1 delineating steps for formulating base midrange and long-range forecast factors after enablement of the platform and initiated by a unique sequence coded for embodying mathematical simplicity that involves a qualitative projection index, a formulated actual YTD time series, simple quarterly or annual percent change, base preparation for less uncertainty from subsequent automatic multiple forecasts, and first 8 steps of the automatic refinement algorithm sequence specifically by:
(a) establishing a qualitative projection index in Sheet 2 serving as common assumptions uniformly with universally end-result qualitative factors and factors 3 and 4 representing a rate of change in technology and social interaction over time respectively;
(b) using the default option for qualitative estimates or the user's own qualitative estimates for the index in Sheet 2 to establish the weighted portion of the preliminary base midrange forecast factor in Sheet 3 as the initial step in the first part of the automatic refinement algorithm sequence;
(c) outlining an account/data table in the top of Sheet 3 reserved for subsequent user estimated or existing data to be combined with corresponding matching actual data of a similar account/data table in Sheet 4 for subsequently formulating a YTD actual time series that will serve as the source of the quarterly or annual simple percent change of midrange periods in Sheet 7 and Sheet 3;
(d) formulating the second part of the base midrange forecast factor from the sequence in claim 2(c) combined with the weighted portion in claim 2(b) to form the base midrange forecast factor 1 that establishes the base long-range forecast factor 1; and
(e) specifying embodiments that involve the first 8 steps of the automatic refinement algorithm sequence as the qualitative projection index, preliminary base midrange forecast factor, formulation of Sheet 3 account/data table, formulation of actual data match, formulation of actual YTD time series, quarterly or annual percent change, base midrange forecast factor 1, and base long-range forecast factor 1.

3. A process of claim 2, dependent upon formulation of the base forecast factors, that includes the 7 central steps in the automatic refinement algorithm sequence and delineates steps for formatting structural design that provides formats for improvements, source coding of unique reports, and utility with embodiments of: customized time horizons; account/data table for all reports having estimated or existing and actual data; unique reports such as Forecast Overview, ancillary Comprehensive Budget, Plans, Analytical Framework with impacts, and non-sequential entry of internal Information Resources utility for consultation that includes:
(a) establishing definite time and horizon options in Sheet 2 of hours, months, or years and unique customizable length of midrange and long-range horizons in Sheet 2 for use throughout having defaults as years, 5 for midrange, and 15 for long-range and maximums of 60 months or 43,830 hours for midrange and 180 months or 131,490 hours for long-range horizons to be applied to all forecast reports;
(b) formatting of the estimated account/data table in Sheet 3 necessary for all reports that contain estimated or existing data having financial or non-financial row names of preset account or user-defined items, fonts, and Areas of Interest category column headings subsequently from Sheet 2 that enable capability for multiple strategic or planning areas without reinitialization and provide the estimated data for Forecast Overview by total of Sheet 3 columns and for Category or Fund Report by total of Sheet 3 rows for subsequent supplement by optional filters for Sheets 4-6;
(c) formatting a color scheme in Sheet 3 allowing the user to select “Bright Color Shading” or a more subdued shading for different purposes applicable to the Forecast Overview and Category or Fund Report;
(d) designing uniform structure by format and coding of the printable Forecast Overview in Sheet 3 that helps issue recognition and alternative review giving up-to-date insight on goals, areas and elements chosen, or multiple strategic management approaches through simultaneous assessment by having—
(1) an optionally allocated aspiration or priorities section with unique side-by-side columns coded for simultaneous forecasts of allocated distribution from current to long-range periods and concatenated with user-chosen time and horizon options having rows for the user's alphanumeric goals, objectives, mission displayed as discrete quantities rather than routine graphs and a total projected balance as of date beneath this section;
(2) an activity/data report section with side-by-side columns coded for operations, development, and strategic forecasts—having row names to be populated by full name of selected area(s) of interest from Sheet 2 and data from Sheet 3 account/data table with columns of estimated or budgeted data, actual data from Sheet 4 account/data table, total or general data, and capital data—capable of simultaneously assessing multiple approaches and strategic or planning areas such that forecast columns are to be concatenated with user-chosen periods; and
(3) an aspiration reallocation section coded for the unique capability of real-time user interface to reset priorities without reinitialization in response to unexpected changes or events toward helping adaptability;
(e) designing uniform structure by format and coding of the printable Category or Fund Report in Sheet 3 having—
(1) an account category or fund section with side-by-side columns coded for operations, development, and strategic forecasts having row names to be populated by Sheet 3's account/data table and columns of estimated or budgeted data, actual data, total or general data, and capital data to be concatenated with user-chosen time and horizon options; and
(2) a unique Program Highlights section coded for user interface that expresses the short-long term direction to be taken through current, midrange, and long-range textual highlights of operations and capital finally decided upon indicating a roadmap for implementation and authenticated by status of taxes, audit, and authorization in a layout suitable for inclusion in an annual report or summary supplementing any necessary visualizations;
(f) designing structure by format and coding of the printable automated Comprehensive Budget in Sheet 3 as ancillary to the Forecast Overview, Category or Fund Report, and Analytical Framework coded for entering alternatives' data first and user-interfaced line-item categories combining assets, income, liabilities, and expenses that eliminates the need to recompute amounts for separate financial reports each time one is needed and indicates the practical ability to implement after all forecasts and conditions are reported being formatted with code involving—
(1) an operation status having column names of “Annual Interest”, “This Week”, “Monthly”, and “End of Year”;
(2) a longer perspective having column names of “Interest Earned”, “Interest Paid”, and forecasted midrange “Est” and long-range “Est” concatenated to chosen time and horizons options; and
(3) alternatives' data for installment or periodic payments having column names of “Annual Interest”, “# of periods, np”, “amount, A”, “payments, PMT”, “yr-end total”, “accrued(bal)”, and “np til end of yr” beneath the line item categories;
(g) designing structure by format and coding of the optional and printable Scheduling Report in Sheet 3 as ancillary to Plans 1-32 helping the user best align and control resources for implementation through row names to be populated with activity indicated for each user-chosen unit, function, or demand and column names for increases, decreases, total, and scheduled dates and resources from Sheets 4-6;
(h) formatting of the actual account/data table rows and column headings in Sheet 4 the same as that of the account/data table in Sheet 3 and having code in Sheet 4 for matching Plans 1-32 actual data with data filtered from Sheet 3 provides the actual data for the Forecast Overview by total of Sheet 4 columns and for the Category or Fund Report by total of Sheet 4 rows;
(i) designing uniform structure by format and coding of printable Plans 1-32 in Sheets 4-6 that provide minute details and logistic insights not conveyed by dashboards, help handle new developments, retain focus, and provide 24/7 visibility for alternatives review, implementation control levels, and adjustment through administrative, data, unique accuracy check, detailed notes, and capital budget sections for each plan given—
(1) an administrative section that specifies officers, members, and sponsors or partners of each activity, program, project, event, system, or work group;
(2) a data section that provides objective of the activity, filtered Sheet 3 row names and budgeted or estimated quantity, actual data, quantity due, weight assigned to each row for prioritizing, and estimated midrange total for each row;
(3) structure of the unique accuracy check of entries not subject to data validation or comments improves data integrity by helping prevent transcription errors and keep data designated to remain unchanged through the unique Stays Same feature significant for financial controls or other authorizations;
(4) detailed notes include available resource defaults of prices, lead times, number needed per activity item, facility or user's own resource names and a projected balance as of date “Scheduled for” to be augmented by Sheet 2's 90-day calendar readily accessed from the Name Box, and information on any associated capital budget line items from assessments, donations, property inventory or sales; and
(5) the capital budget section shows status by year, columns for budgeted and actual, and is to be automatically populated when in financial mode by assessments, donations, and property inventory/sales capital account items with income, expense, and balance totals;
(j) formatting and coding the YTD time series in Sheet 7 to be initiated from actual data in Sheet 4's account/data row total that will populate Sheet 7's actual monthly and yearly data in real time serving as the source for the simple quarterly or annual percent change in Sheet 7 and Sheet 3 that is used in computing the second part of the midrange forecast factor as well as initiate the Analytical Framework;
(k) designing uniform structure by format and coding of the printable unique Analytical Framework in Sheet 7 that provides short-long term levels for evaluation, and includes percent error to further help reduce the level of uncertainty as well as an optional forecasted impacts section that provides an indication of conditions in future operating or functional environments for better reliability in implementation given—
(1) a yearly forecast section constituting steps 14-15 of the automatic refinement algorithm sequence with (i) step 14 are raw forecasts coded in columns “YEAR” and “Actual YTD” columns to be populated for current 5-year period data from the Sheet 7 YTD time series and estimate for the next 10 years cumulatively updated by each 5-year period for greater accuracy and a “% Ch” column, (ii) step 15 is an adjusted forecasts section coded in columns of user-chosen time period, “BALANCES”, and “CAPITAL ITEMS” and up to 15 user-chosen time preiod rows each to be populated with inclusion of percent error allowing for reevaluations, and (iii) a “User-defined Chart Area” optionally to be printed in Sheet 8 as part of a user-opted computer dashboard; and
(2) an optional unique impacts section coded in columns of “Estimate”, “Actual”, “% Change”, and “Projections with a 2% Improvement” with sub columns of half the midrange period, midrange period, and long-range period for needs of “Domestic Economies” and “Basic Necessities” and impacts of “Technology Impacts” and “Crisis Management Impacts” serving as a basis for better decisions and implications as well as a graphic “Chart Area”;
(l) designing structure by format and coding of the optional and printable Research or Historical Data Report interchangeable designation in Sheet 7 as ancillary to Plans 1-32 and Analytical Framework as reference matter coded for year, user-chosen data row item names from Sheet 2, user-chosen customized or default column names of “Number”, “Quantity”, “Group”, “Unit Cost”, “Time”, and “Distance” from Sheet 2, and chart area;
(m) designing structure by format and coding of the optional utilities being the 90-day Calendar, Information Resources, and Name Box given—
(1) a 90-day Calendar in Sheet 2 as ancillary to Plans 1-32 is coded to display 45 days before and 45 days after a user-entered date to avoid scheduling conflicts;
(2) an Information Resources printable utility in Sheet 2 as ancillary to the Analytical Framework has sort instructions applicable to its non-sequential entries, filter instructions applicable to Sheet 3 account/data table, and coding for contents of columns uniquely designed to provide an optional relational database internally without an external source and specialized internal files of URLs, publications, sources, or services for consultation, reference, or storage that supplements analysis and evaluation with sufficient detail from multiple indications of identification, location data, contact information, and status; and
(3) a Name Box structured in Sheet 2 with definitions that reserve specific locations for names of “Dates” (90 day Calendar), “Definitions”, “Examples”, Sheet 3 account/data table filter locations, “GoalNames”, “InfoRes”,“Navigation”, “ObjectiveNames”, “PersonalBudget”, “SecurityMeas”, and “StoreInstructions” that are accessible workbook-wide in unprotected areas; and
(n) specifying the embodiments that involve the central 7 steps of the automatic refinement algorithm sequence as selection of time-horizon periods, estimated account/data table format, forecasted overview, actual account/data table format, actual time series data, yearly forecasts, and analytical evaluation or reassessment;

4. A process of claim 3, dependent upon the structural design, that includes the last 9 steps of the automatic refinement algorithm sequence and delineates steps for initializing operation of the structural design through entry settings, optional allocations, areas of interest, aspirations, other features, security measures, activation with data entry, and help worksheets given—
(a) entry settings, after naming help worksheets of Sheets 1 and 8, for common assumptions being the default or user-defined qualitative projection index factors, beginning year, time periods and horizons, optional reset instruction, navigation, and financial or non-financial mode that initialize workbook-wide operational settings;
(b) optional allocation settings for each of four goal names and five objective names help set the user's aspirations or priorities;
(c) areas of interest with definitions of “AREA OF INTEREST CATEGORIES” for units, functions, or demands and “RELATED ACTIVITY OF CATEGORY CHOSEN” with cell references for Sheet 3's unit, function, or demand rows and columns help direct extent of functionality and enable multiple strategic or planning areas or novel multiple strategic management approaches' elements simultaneously;
(d) aspirations settings for an overall textual statement of goals, objectives, mission, and type of unit or demand to be made in Sheet 3 indicate the common purpose or primary levels the user(s) desire to reach or achieve;
(e) other features with settings for optional selection of impacts in technology or crisis management, defaults or user-customized items for research or historical reports, and necessities data of housing and job security help provide data for the impact section of the Analytical Framework;
(f) security measures for password protecting Sheet 2 through Sheet 8 subsequently unlocking Sheet 3 to temporarily unhide account/data table's rows and columns and hiding worksheets as necessary to protect the workbook if there is more than one user;
(g) user interface data entry after activation instructions secures data and initializes operation with—
(1) entry of user-chosen or default names in Sheet 3's account/data table depending on mode, initialization of filter settings in Sheet 3's account/data table and hiding designated Sheet 2 columns and optional password protected worksheets and workbook structure when there are more than one user secures data preparation;
(2) activation initializing through entering estimated or budgeted data in Sheet 3's account/data table updates the base forecast factors producing the 2nd forecast factors and 1st forecast of reports; and
(3) entering actual data in Sheets 4-6 when available initiates updates to time series, yearly forecasts, and 2nd forecast factors producing the 3rd forecast factors and 2nd forecast of reports that updates the Analytical Framework and reiterates;
(h) initializing help worksheet Sheet 1 that identifies types of users, advantages, special features, access map, and examples conveniently indexing and exemplifing various types of applications adding operational ease with—
(1) types of users identified as non-profits, businesses, institutions, students, governments, corporations, individuals, associations, and groups;
(2) advantages identified in an elliptical circle as: simple and easy, less time to construct; minimizes data maintenance; less uncertainty from multiple updates; greater sustainability, greater convenience; and improved efficiency and productivity indicate some significant improvements in combination over existing capabilities in forecasting software and strategic management tools;
(3) special features identified in an elliptical circle as: customized forecast periods, projection index; real-time priorities reset of goals, objectives; automatic multiple refinement of forecasts & analysis; forecasted program highlights, comprehensive budgets; technology impacts; and internal information resources indicate some significant improvements in combination over existing features in forecasting software and strategic management tools;
(4) the access map divided into access sections of “Restricted” and “All Users” referencing applicable worksheets and major areas or features under Restricted section and applicable worksheets and major areas or uses under All Users provides an index to the invention; and
(5) examples for 6 different categories of applications specified as “General”, “Parental Aide”, “Organizational”, “Business”, “Corporate”, and “Government” that provide instructions and screenshots to better help the user develop applications appropriate to their needs;
(i) initializing printable help worksheet Sheet 8 from Sheet 7 instructions on creating and storing computer dashboards, other inserts, or created forms to efficiently supplement data or visualization needs; and
(j) specifying the embodiments of the last 9 steps of the automatic refinement algorithm sequence as entering the qualitative projection index data and the 8 steps upon activation as entering estimated or budgeted data, update to base forecast factors being the 2nd forecast factors, 1st forecast of reports, entering actual data as available, update to yearly forecasts, update to forecast factors 2 being the 3rd forecast factors, 2nd forecast of reports, and update to analytical framework without having to reset initial data entry or settings.
